(19) United States
(12) Patent Application Publication
(10) Pub. No.: US 2015/0368593 A1
(43) Pub. Date: Dec. 24, 2015

(54) CLEANING COMPOSITION HAVING IMPROVED VERTICAL CLING

(71) Applicant: THE ARMOR ALL/STP PRODUCTS COMPANY, Danbury, CT (US)

(72) Inventors: Ashot K. SEROBIAN, Martinez, CA (US); Eric Paul LEE, Mountain View, CA (US); Nicholas S. NORBERG, San Ramon, CA (US)

(21) Appl. No.: 14/729,712

(22) Filed: Jun. 3, 2015

Related U.S. Application Data
(60) Provisional application No. 62/015,762, filed on Jun. 23, 2014.

(51) Int. Cl. C11D 3/33; C11D 1/75; B08B 3/02; C11D 3/22

(52) U.S. Cl. CPC C11D 3/33; C11D 3/222; C11D 1/75; B08B 3/02

(57) ABSTRACT

This disclosure provides cleaning compositions having improved vertical cling. In particular, this disclosure relates to sprayable cleaning compositions containing at least one polysaccharide that are useful for cleaning vertical or inclined surfaces. This disclosure provides cleaning compositions that contain a rheology modifier in an amount of about 0.1 weight percent to about 1 weight percent (i.e., a polysaccharide), an alkalinity source (e.g., chelating agent) in an amount of about 1 weight percent to about 8 weight percent, a surfactant in an amount of about 0.3 weight percent to about 5 weight percent, and water in an amount of about 80 weight percent to about 98 weight percent. The cleaning compositions have a viscosity from about 200 cps to about 1000 cps and exhibit a Vertical Cling time of greater than about 5 minutes. The cleaning compositions effectively remove organic and inorganic soils from wheel, tire and automotive surfaces.

### RELATED APPLICATION

This application claims the benefit of U.S. Provisional Application Ser. No. 62/015,762, filed on Jun. 23, 2014, which is incorporated herein by reference in its entirety.

### BACKGROUND

1. Field of the Disclosure

This disclosure relates to cleaning compositions having improved vertical cling. In particular, this disclosure relates to sprayable cleaning compositions containing at least one polysaccharide that are useful for cleaning vertical or inclined surfaces. The cleaning compositions effectively remove organic and inorganic soils from wheel, tire and automotive surfaces.

2. Discussion of the Background Art

A great variety of cleaning compositions have been described in the art. Even though, the currently known compositions provide good performance with regard to cleaning performance, manufacturers of surface cleaning compositions are continuously searching for new components that will improve the effectiveness of the compositions. Indeed, it has been found by consumer research that cleaning performances of compositions can be further improved; more especially, when used to treat inclined or vertical hard surface. Indeed, one of the main technical problems when using composition for treating this specific kind of surface, is that the compositions do not cling well to the surface to be treated and drain off from the surface too fast.

Thus, there is still a need to improve such composition and to obtain process of treating inclined or vertical hard surface, which avoid the above defined disadvantages. Indeed, there is a constant need for compositions that do not drain off from the surface too fast and that have good cleaning performances; but also that are easy to apply in order to reduce the amount of effort required from the user and to avoid or minimize the contact of the user with the cleaning composition. It is, thus, desirable that the compositions clings to the surface to be treated sufficiently enough in order to maintain a substantial concentration of cleaning composition on these vertical or inclined surfaces for a time long enough to allow soil swelling to take place and to enable the product to work.

There is a need in the art for improved cleaning compositions for cleaning vertical or inclined surfaces, e.g., automotive, tire and wheel surfaces, without the disadvantages of the prior art compositions.

The present disclosure also provides many additional advantages, which shall become apparent as described below.

### SUMMARY OF THE DISCLOSURE

This disclosure relates to cleaning compositions having improved vertical cling. In particular, this disclosure relates to sprayable cleaning compositions containing at least one polysaccharide that are useful for cleaning vertical or inclined surfaces. The cleaning compositions effectively remove organic and inorganic soils from wheel, tire and automotive surfaces.

This disclosure relates in part to cleaning compositions containing a rheology modifier in an amount of about 0.1 weight percent to about 1 weight percent (i.e., a polysaccharide), an alkalinity source (e.g., chelating agent) in an amount of about 1 weight percent to about 8 weight percent, a surfactant (e.g., nonionic, anionic, cationic and/or amphoteric surfactant) in an amount of about 0.3 weight percent to about 5 weight percent, and water in an amount of about 80 weight percent to about 98 weight percent. The cleaning compositions have a viscosity from about 200 cps to about 1000 cps and exhibit a Vertical Cling time of greater than about 5 minutes as measured by Vertical Cling Test VCT1.

The disclosure also relates in part to a method for cleaning a surface (e.g., wheel, tire or automotive surface). The method involves applying a cleaning composition to the surface to be cleaned; allowing the cleaning composition to be contacted with the surface for a period of time sufficient to dissolve and/or emulsify organic soils; and rinsing the cleaning composition and dissolved and/or emulsified organic soils from the surface with water. The cleaning compositions contain a rheology modifier (i.e., a polysaccharide) in an amount of about 0.1 weight percent to about 1 weight percent, an alkalinity source (e.g., chelating agent) in an amount of about 1 weight percent to about 8 weight percent, a surfactant (e.g., nonionic, anionic, cationic and/or amphoteric surfactant) in an amount of about 0.3 weight percent to about 5 weight percent, and water in an amount of about 80 weight percent to about 98 weight percent. The cleaning compositions have a viscosity from about 200 cps to about 1000 cps and exhibit a Vertical Cling time of greater than about 5 minutes as measured by Vertical Cling Test VCT1.

Further objects, features and advantages of the present disclosure will be understood by reference to the following drawings and detailed description.

### BRIEF DESCRIPTION OF THE DRAWINGS

FIG. 1 shows cleaning results of wheel cleaning compositions in accordance with this disclosure.

FIG. 2 shows results of Vertical Cling testing of wheel cleaning compositions in accordance with this disclosure.

FIG. 3 shows results of Vertical Cling testing of wheel cleaning compositions in accordance with this disclosure.

### DETAILED DESCRIPTION OF THE PREFERRED EMBODIMENT

This disclosure is not limited to particularly exemplified systems or process parameters that may, of course, vary. The terminology used herein is for the purpose of describing particular embodiments of the disclosure only, and is not intended to limit the scope of the disclosure in any manner.

As used herein, effective amounts are generally those amounts listed as the ranges or levels of ingredients in the descriptions, which follow hereto. Unless otherwise stated, amounts listed in percentage (“%”) are in weight percent of the total composition. Compositions are generally expressed in weight percent equivalent to 100% active material (active weight basis) and thus carrier or solvent weight is not included in the expressed percentage.

As used herein, “viscosity” is the kinematic viscosity in centipoise (cps), measured at 25° C. (77° F.) using a Brookfield LV spindle #2 at 30 rpm for 2 minutes, unless otherwise specified.

As used herein, the term “organic soil removing agent” refers to a nonionic, anionic, cationic and/or amphoteric surfactant and alkalinity sources that are capable of dissolving and emulsifying organic soils.

In accordance with this disclosure, a cleaning composition containing at least one polysaccharide is provided. The cleaning compositions exhibit high sheering properties and improved Vertical Cling time. The cleaning compositions can be used for cleaning tire and wheel surfaces and also for automotive surfaces. Polysaccharides exhibit unique visco-elastic properties when dissolved in water turning the mixture from a viscous stationary solution to a more free-flowing solution when a slight shear, either by mixing, shaking, pouring, or brushing is applied, and reverts back to a thick viscous solution when shearing stops. In accordance with this disclosure, selected polysaccharides including, for example, cellulose, chitin, dextran, xanthan gum, and other gums are used in conjunction with conventional wheel cleaning components such as an acid or alkaline-based cleaning formula to dramatically improve the cleaning power.

Formulating a cleaning composition with polysaccharides provides cleaning on a soiled wheel/tire or automotive surface in the following steps: 1) surfactants and chelating agents (i.e., alkalinity source as used herein) loosen stubborn dirt, grime, and brake dust from the wheel/ tire or automotive surface; 2) polysaccharide thickens to a gel on the wheel/ tire or automotive surface providing a much longer dwell time for cleaning compared to any current tire, wheel or automotive cleaner and acts as a “glue” picking up all the loosened dirt, grim and brake dust; 3) when hosing off, the gelled formula will “peel off” taking along with it all the dirt, grime and brake dust from the tire, wheel or automotive surface.

Conventional wheel, tire and automotive cleaners typically recommend a dwell time of no more than 30 seconds in their directions. Short dwell times may be required to limit the product from dripping off the wheel before scrubbing, and to prevent surface damage that may occur in some instances with longer dwell times. In contrast, the cleaning methods of this disclosure allow for prolonged dwell time of over 5 minutes. The unique visco-elastic property of polysaccharides causes the polysaccharide chains to stretch when shear force is applied, allowing for easy spraying onto wheel, tire and automotive surfaces. When left to settle, the polysaccharide chains begin to recoil, returning to their relaxed state, and in the process will “pick up” loosened dirt, grime and brake dust from the wheel/tire surface.

### Composition

The compositions of this disclosure comprise combinations of a rheology modifier, a surfactant and an alkalinity source (e.g., chelating agent), that are combined to provide a cleaning composition having a suitable substantivity to a vertical surface, defined by a Vertical Cling time, such that when applied to a vertical surface, the compositions do not run, drip or flow excessively from the point of application. The compositions of this disclosure contain at least one rheology modifier (i.e., polysaccharide polymer) that contributes to thickening and the desirable rheological properties that provide the compositions with Vertical Cling time of greater than about 5 minutes as measured by Vertical Cling Test VCT1 described herein.

A preferred cleaning composition in accordance with this disclosure contains xanthan gum (preferably about 0.1 weight percent to about 0.6 weight percent), ethylenediaminetetraacetic acid (EDTA) or salts of ethylenediaminetetraacetic acid (EDTA) (preferably about 5 weight percent to about 7 weight percent), N-alkyl(C₁₂₋₁₆)dimethylamine oxides (cocamine oxide) (preferably about 0.5 weight percent to about 3 weight percent), sodium hydroxide (about 0.5 weight percent to about 1.5 weight percent), and deionized water (about 85 weight percent to about 93 weight percent).

The cleaning compositions of this disclosure cling to the wheel surface allowing longer contact time. The nonionic, anionic, cationic and/or amphoteric surfactant and alkalinity source or chelating agent help lift the soil that has been loosened and broken down. Thickening may also slow the evaporation rate. Thickening improves the safety by making the product harder to ingest. The thickening of the cleaning compositions with the polysaccharide improves performance at lowered levels of ingredients.

The Vertical Cling time represents a convenient and easy to measure parameter that describes the overall rheological behavior of the compositions of this disclosure, which are characterized by their ability to cling to a vertical surface without running, dripping or flowing excessively. The compositions of this disclosure have sufficient vertical clinging characteristics to exhibit a Vertical Cling time of greater than about 5 minutes. Compositions that are generally too viscous and also exhibit no measurable flow under conditions of the Vertical Cling test that is to say exhibit a Vertical Cling time significantly greater than 5 minutes, lack utility in that they are generally too viscous for ease of dispensing and for ease of application and spreading across a treated surface. Conversely, compositions that are generally less viscous and also exhibit a Vertical Cling time significantly less than 5 minutes are found to have insufficient cling to vertical surfaces. The compositions of this disclosure exhibiting a Vertical Cling time about 5 minutes, or about 10 minutes, or about 15 minutes, generally tend to also exhibit ease of application with no excessive running or dripping from the desired application area enabling a minimum amount of the cleaning composition to be employed where needed. While the measured viscosity of the compositions of this disclosure and the Vertical Cling time are not necessarily proportional, it is generally found that compositions of this disclosure including those compositions having measured viscosities above 300 centipoise (cps) will exhibit a Vertical Cling time of greater than about 5 minutes.

Illustrative viscosities of the cleaning compositions of this disclosure range from about 200 cps to about 1000 cps, and preferably between the ranges of 200 and 600 cps, more preferably between about 300 and 500 cps. The Vertical Cling time of the cleaning compositions of this disclosure is greater than about 5 minutes, greater than about 10 minutes, or greater than about 15 minutes.

### Rheology Modifier

At least one rheology modifier used in the sprayable cleaning compositions of this disclosure is a natural polymer or derivatized natural polymer or polysaccharide. Illustrative polysaccharides include, for example, cellulose, chitin, dextran, xanthan gum, and the like.

In particular, some non-limiting examples of natural polymers and derivatized natural polymers suitable for use in the present disclosure include polysaccharide polymers, which include substituted cellulose materials like carboxymethylcellulose, ethyl cellulose, hydroxyethylcellulose, hydroxypropyl-cellulose, hydroxymethylcellulose, succinoglycan and naturally occurring polysaccharide polymers like xanthan gum, guar gum, locust bean gum, tragacanth gum, carrageen gum or derivatives thereof. Also suitable are polypeptides and proteins, for example, but not limited to gelatin and gelatin derivatives, peptin, peptone, and the like, as well as polysaccharide and peptide copolymers, such as peptidoglycans and the like.

The compositions of this disclosure contain at least one natural polymer or derivatized natural polymer or polysaccharide that contributes to both thickening and the rheological structure of the cleaning compositions and contributes to the desirable vertical clinging characteristics of the present disclosure. Other rheology modifiers may be used in combination with the natural polymer or derivatized natural polymer or polysaccharide. The other rheology modifiers may be selected from organic polymers, natural polymers, inorganic thickeners, and their derivatives. Mixtures of the rheology modifiers may also be suitably employed.

The natural polymers or derivatized natural polymers or polysaccahrides are used in amounts of about 0.1 weight percent to about 1 weight percent, preferably from about 0.1 weight percent to about 0.8 weight percent, and more preferably from about 0.1 weight percent to about 0.6 weight percent,

In addition to at least one polysaccharide, the cleaning compositions of this disclosure may contain one or more other rheology modifiers. The one or more other rheology modifiers are selected from organic polymers, natural polymers, inorganic thickeners, and their derivatives.

In general, any suitable organic polymer may be employed as another rheology modifier, such organic polymer generally referring to the class of synthetic or man-made polymers. The compositions of this disclosure may employ water-soluble or water dispersible polymers. The compositions of this disclosure may employ nonionic (neutral and/or non-ionizable), anionic and/or cationic polymers, and their mixtures. Suitable anionic polymers include those with ionizable groups that are at least partially anionic in solution, that is carrying a negative charge in solution, or which can be at least partially or fully neutralized to be at least partially or fully anionic in solution. Suitable cationic polymers include polymers that are ionizable (i.e. capable of being protonated) and those with permanent cationic groups, that is carrying a permanent positive charge, in solution. The compositions of this disclosure may employ hydrophilic polymers, hydrophobic polymers or polymers exhibiting both properties owing to the presence of hydrophilic and hydrophobic monomer moieties. Suitable hydrophilic polymers are those that are attracted to surfaces and are absorbed thereto without covalent bonds. Examples of suitable polymers include the polymers and co-polymers of N,N-dialkyl acrylamide, acrylamide, and certain monomers containing substituted and/or unsubstituted quaternary ammonium groups and/or amphoteric groups that favor substantivity to surfaces, along with co-monomers that favor adsorption of water, such as, for example, acrylic acid and other acrylate salts, sulfonates, betaines, and ethylene oxides. Water soluble or water dispersible cationic polymers may be suitable for their charge dissipative effect, antistatic, surface lubricating and potential softening benefits.

With respect to the synthesis of a water soluble or water dispersible cationic copolymer, the level of the first monomer, which has a permanent cationic charge or that is capable of forming a cationic charge on protonation, is typically between 3 and 80 mol % or alternatively between 10 to 60 mol % of the copolymer. The level of second monomer, which is an acidic monomer that is capable of forming an anionic charge in the composition, when present is typically between 3 and 80 mol % or alternatively between 10 to 60 mol % of the copolymer. The level of the third monomer, which has an uncharged hydrophilic group, when present is typically between 3 and 80 mol % or alternatively between 10 to 60 mol % of the copolymer. When present, the level of uncharged hydrophobic monomer is less than about 50 mol % or alternatively less than 10 mol % of the copolymer. The molar ratio of the first monomer to the second monomer typically ranges from 19:1 to 1:10 or alternatively ranges from 9:1 to 1:6. The molar ratio of the first monomer to the third monomer is typically ranges from 4:1 to 1:4 or alternatively ranges from 2:1 to 1:2.

The average molecular weight of the copolymer typically ranges from about 5,000 to about 10,000,000, with the suitable molecular weight range depending on the polymer composition with the proviso that the molecular weight is selected so that the copolymer is water soluble or water dispersible to at least 0.01% by weight in distilled water at 25° C.

Examples of permanently cationic monomers include, but are not limited to, quaternary ammonium salts of substituted acrylamide, methacrylamide, acrylate and methacrylate, such as trimethylammoniumethylmethacrylate, trimethylammoniumpropylmethacrylamide, trimethylammoniumethylmethacrylate, trimethylammoniumpropylacrylamide, 2-vinyl N-alkyl quaternary pyridinium, 4-vinyl N-alkyl quaternary pyridinium, 4-vinylbenzyltrialkylammonium, 2-vinyl pip eri-dinium, 4-vinyl piperidinium, 3-alkyl 1-vinyl imidazolium, diallyldimethylammoni-um, and the ionene class of internal cationic monomers as described by D. R. Berger in Cationic Surfactants, Organic Chemistry, edited by J. M. Richmond, Marcel Dekker, New York, 1990, ISBN 0-8247-8381-6, which is incorporated herein by reference. This class includes co-poly ethylene imine, co-poly ethoxylated ethylene imine and co-poly quaternized ethoxylated ethylene imine, co-poly [(dimethylimino)trimethylene (dimethylimino)hexamethylene disalt], co-poly [(diethylimino)trimethylene (dimethylimino)trimethylene disalt], co-poly [(dimethylimino)2-hydroxypropyl salt], co-polyquarternium-2, co-polyquarterni-um-17, and co-polyquarternium-18, as described in the International Cosmetic Ingredient Dictionary, 5th Edition, edited by J. A. Wenninger and G. N. McEwen, which is incorporated herein by reference. Other cationic monomers include those containing cationic sulfonium salts such as co-poly-1[3-methyl-4-(vinyl-benzyloxy)phenyl] tetrahydrothiophenium chloride. Especially suitable monomers are mono- and di-quaternary derivatives of methacrylamide. The counterion of the cationic co-monomer can be selected from, for example, chloride, bromide, iodide, hydroxide, phosphate, sulfate, hydrosulfate, ethyl sulfate, methyl sulfate, formate, and acetate.

Examples of monomers that are cationic on protonation include, but are not limited to, acrylamide, N,N-dimethylacrylamide, N,N di-isopropylacryalmide, N-vinylimidazole, N-vinylpyrrolidone, ethyleneimine, dimethylaminohydroxypropyl diethylenetriamine, dimethylaminoethylmethacrylate, dimethylaminopropyl-methacryl-amide, dimethylaminoethylacrylate, dimethylaminopropylacrylamide, 2-vinyl pyridine, 4-vinyl pyridine, 2-vinyl piperidine, 4-vinylpiperidine, vinyl amine, diallylamine, methyldiallylamine, vinyl oxazolidone; vinyl methyoxazolidone, and vinyl caprolactam.

Monomers that are cationic on protonation typically contain a positive charge over a portion of the pH range of 2-11. Such suitable monomers are also presented in Water-Soluble Synthetic Polymers: Properties and Behavior, Volume II, by P. Molyneux, CRC Press, Boca Raton, 1983, ISBN 0-8493-6136. Additional monomers can be found in the International Cosmetic Ingredient Dictionary, 5th Edition, edited by J. A. Wenninger and G. N. McEwen, The Cosmetic, Toiletry, and Fragrance Association, Washington D.C., 1993, ISBN 1-882621-06-9. A third source of such monomers can be found in Encyclopedia of Polymers and Thickeners for Cosmetics, by R. Y. Lochhead and W. R. Fron, Cosmetics & Toiletries, vol. 108, May 1993, pp 95-135. All three references are incorporated herein.

Examples of acidic monomers that are capable of forming an anionic charge in the composition include, but are not limited to, acrylic acid, methacrylic acid, ethacrylic acid, dimethylacrylic acid, maleic anhydride, succinic anhydride, vinylsulfonate, cyanoacrylic acid, methylenemalonic acid, vinylacetic acid, allylacetic acid, ethylidine-acetic acid, propylidineacetic acid, crotonic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, citraconic acid, vinylbenzoic acid, N-vinylsuccinamidic acid, mesaconic acid, methacroylalanine, acryloylhydroxyglycine, sulfoethyl methacrylate, sulfopropyl acrylate, and sulfoethyl acrylate. Exemplary acid monomers also include styrenesulfonic acid, 2-methacryloyloxymethane-1-sulfonic acid, 3-methacryloyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid and vinyl phosphoric acid. Suitable monomers include acrylic acid, methacrylic acid and maleic acid. The copolymers useful in this disclosure may contain the above acidic monomers and the alkali metal, alkaline earth metal, and ammonium salts thereof.

Examples of monomers having an uncharged hydrophilic group include but are not limited to vinyl alcohol, vinyl acetate, vinyl methyl ether, vinyl ethyl ether, ethylene oxide and propylene oxide. Also suitable are hydrophilic esters of monomers, such as hydroxyalkyl acrylate esters, alcohol ethoxylate esters, alkylpolyglycoside esters, and polyethylene glycol esters of acrylic and methacrylic acid.

Finally, examples of uncharged hydrophobic monomers include, but are not limited to, C₁-C₄ alkyl esters of acrylic acid and of methacrylic acid.

Suitable copolymers are formed by copolymerizing the desired monomers. Conventional polymerization techniques can be employed. Illustrative techniques include, for example, solution, suspension, dispersion, or emulsion polymerization. An exemplary method of preparation is by precipitation or inverse suspension polymerization of the copolymer from a polymerization media in which the monomers are dispersed in a suitable solvent. The monomers employed in preparing the copolymer may be water soluble or sufficiently soluble in the polymerization media to form a homogeneous solution. They readily undergo polymerization to form polymers which are water-dispersible or water-soluble. The exemplary copolymers contain acrylamide, methacrylamide and substituted acrylamides and methacrylamides, acrylic and methacrylic acid and esters thereof. Suitable synthetic methods for these copolymers are described, for example, in Kirk-Othmer, Encyclopedia of Chemical Technology, Volume 1, Fourth Ed., John Wiley & Sons.

Other examples of polymers that provide sheeting and anti-spotting benefits are polymers that contain amine oxide hydrophilic groups. Polymers that contain other hydrophilic groups such a sulfonate, pyrrolidone, and/or carboxylate groups can also be used. Examples of desirable poly-sulfonate polymers include polyvinylsulfonate, and also include polystyrene sulfonate, such as those sold by Monomer-Polymer Dajac (1675 Bustleton Pike, Feasterville, Pa. 19053). A typical formula is as follows: [CH(C₆H₄SO₃Na)—CH₂]ₙ—CH(C₆H₅)—CH₂ wherein n is a number to give the appropriate molecular weight as disclosed below.

Typical molecular weights are from about 10,000 to about 1,000,000, or alternatively from about 200,000 to about 700,000. Exemplary polymers containing pyrrolidone functionalities include polyvinyl pyrrolidone, quaternized pyrrolidone derivatives (such as Gafquat 755N from International Specialty Products), and co-polymers containing pyrrolidone, such as polyvinylpyrrolidone/dimethylamino-ethyl-methacrylate (available from ISP) and polyvinyl pyrrolidone/acrylate (available from BASF). Other materials can also provide substantivity and hydrophilicity including cationic materials that also contain hydrophilic groups and polymers that contain multiple ether linkages. Cationic materials include cationic sugar and/or starch derivatives and the typical block copolymer detergent surfactants based on mixtures of polypropylene oxide and ethylene oxide are representative of the polyether materials. The polyether materials are less substantive, however.

Also suitable are polymers comprising water-soluble amine oxide moieties. It is believed that the partial positive charge of the amine oxide group can act to adhere the polymer to the surface of the surface substrate, thus allowing water to “sheet” more readily. To the extent that polymer anchoring promotes better “sheeting”, then higher molecular materials are suitable. Increased molecular weight improves efficiency and effectiveness of the amine oxide-based polymer. Suitable polymers of this disclosure may have one or more monomeric units containing at least one N-oxide group. At least about 10%, suitably more than about 50%, more suitably greater than about 90% of said monomers forming said polymers contain an amine oxide group. These polymers can be described by the general formula: P(B) wherein each P is selected from homopolymerizable and copolymerizable moieties which attach to form the polymer backbone, suitably vinyl moieties, e.g. C(R)2=C(R)2, wherein each R is H, C1-C12, alternatively C1-C4 alkyl(ene), C6-C12 aryl(ene) and/or B; B is a moiety selected from substituted and unsubstituted, linear and cyclic C1-C12 alkyl, C1-C12 alkylene, C1-C12 heterocyclic, aromatic C6-C12 groups and wherein at least one of said B moieties has at least one amine oxide group present; u is from a number that will provide at least about 10% monomers containing an amine oxide group to about 90%; and t is a number such that the average molecular weight of the polymer is from about 2,000 to about 500,000, alternatively from about 5,000 to about 250, 000, and also alternatively from about 7,500 to about 200,000. Exemplary polymers also include poly(4-vinylpyridine N-oxide)polymers (PVNO), wherein the average molecular weight of the polymer is from about 2,000 to about 500,000, alternatively from about 5,000 to about 400,000, and also alternatively from about 7,500 to about 300,000. In general, higher molecular weight polymers are suitable. Often, higher molecular weight polymers allow for use of lower levels of the polymer, which can provide benefits in surface cleaner applications of the compositions of this disclosure. Lower molecular weights for the exemplary poly-amine oxide polymers of the present disclosure are due to greater difficulty in manufacturing these polymers in higher molecular weight.

Some non-limiting examples of homopolymers and copolymers which can be used as water soluble polymers of the present disclosure are: adipic acid/dimethyl-amino-hydroxypropyl diethylenetriamine copolymer; adipic acid/epoxy-propyl diethylenetriamine copolymer; polyvinyl alcohol; methacryloyl ethyl betaine/methacrylates copolymer; ethyl acrylate/methyl methacrylate/methacrylic acid/acrylic acid copolymer; polyamine resins; and polyquaternary amine resins; poly(ethenylformamide); poly-(vinylamine)hydrochloride; poly(vinyl alcohol-co-vinylamine); poly(vinyl alcohol-co-vinylamine); poly(vinyl alcohol-co-vinylamine hydrochloride); and poly(vinyl alcohol-co-vinylamine hydrochloride). Alternatively, said copolymer and/or homopolymers are selected from the group consisting of adipic acid/dimethylaminohydroxypropyl diethylenetriamine copolymer; poly(vinylpyrroli-done/dimethylaminoethyl methacrylate); polyvinyl alcohol; ethyl acrylate/methyl methacrylate/ethacrylic acid/acrylic acid copolymer; methacryloyl ethyl betaine/methacrylates copolymer; polyquaternary amine resins; poly(ethenylformamide); poly(vinylamine)hydrochloride; poly(vinyl alcohol-co-vinylamine); poly(vinyl alcohol-co-vinylamine); poly(vinyl alcohol-co-vinylamine hydrochloride); and poly(vinyl alcohol-co-vinylamine hydrochloride).

Polymers useful in the present disclosure can be selected from the group consisting of copolymers of hydrophilic monomers. The polymer can be linear random or block copolymers, and mixtures thereof. The term “hydrophilic” is used herein consistent with its standard meaning of having at least some affinity for water. As used herein in relation to monomer units and polymeric materials, including the copolymers, “hydrophilic” means substantially water soluble and/or substantially water dispersible. In this regard, “substantially water soluble” or “substantially water dispersible” shall refer to a material that is soluble and/or dispersible in distilled (or equivalent) water, at 25° C., at a concentration of about 0.0001% by weight or greater. The terms “soluble”, “solubility”, “dispersible”, and the like, for purposes hereof, correspond to the maximum concentration of monomer or polymer, as applicable, that can dissolve or disperse in water and/or other solvents, or their mixtures, to form a homogeneous solution, as is well understood to those skilled in the art.

Nonlimiting examples of useful hydrophilic monomers are unsaturated organic mono- and polycarboxylic acids, such as acrylic acid, methacrylic acid, crotonic acid, maleic acid and its half esters, itaconic acid; unsaturated alcohols, such as vinyl alcohol, allyl alcohol; polar vinyl heterocyclics, such as, vinyl caprolactam, vinyl pyridine, vinyl imidazole; vinyl amine; vinyl sulfonate; unsaturated amides, such as acrylamides, e.g., N,N-dimethylacrylamide, N-t-butyl acrylamide; hydroxyethyl methacrylate; dimethylaminoethyl methacrylate; salts of acids and amines listed above; and the like; and mixtures thereof. Some exemplary hydrophilic monomers are acrylic acid, methacrylic acid, N,N-dimethyl acrylamide, N,N-dimethyl methacrylamide, N-t-butyl acrylamide, dimethylamino ethyl methacrylate, thereof, and mixtures thereof.

Polycarboxylate polymers are those formed by polymerization of monomers, at least some of which contain carboxylic functionality. Common monomers include acrylic acid, maleic acid, ethylene, vinyl pyrrolidone, methacrylic acid, methacryloylethylbetaine, etc. Exemplary polymers for substantivity are those having higher molecular weights. For example, polyacrylic acid having molecular weights below about 10,000 are not particularly substantive and therefore do not normally provide hydrophilicity for three rewettings of a treated surface with the compositions of this disclosure, although with higher levels, molecular weights down to about 1000 can provide some results. In general, the polymers should have molecular weights of more than about 10,000. It has also been found that higher molecular weight polymers, e.g., those having molecular weights of more than about 10,000,000, are extremely difficult to formulate and are less effective in providing anti-spotting benefits than lower molecular weight polymers. Accordingly, the molecular weight should normally be, especially for polyacrylates, from about 1,000 to about 10,000,000; alternatively from about 5,000 to about 5,000,000; alternatively from about 10,000 to about 2,500,000; and also suitably from about 20,000 to about 1,000,000.

Non-limiting examples of polymers for use in the present disclosure include the following: poly(vinyl pyrrolidone/acrylic acid) sold under the name “Acrylidone”® by ISP and poly(acrylic acid) sold under the name “Accumer”® by Rohm & Haas. Other suitable materials include sulfonated polystyrene polymers sold under the name Versaflex® sold by National Starch and Chemical Company, especially Versaflex 7000.

Suitable polymers may be selected from the group consisting of water soluble and water dispersible polyacrylate polymers and copolymers containing at least one acrylate monomer, water swellable and alkali swellable polyacrylate polymers and copolymers containing at least one acrylate monomer, non-linear polyacrylate polymers cross-linked with at least one polyalkenyl polyether monomer, film-forming and water swellable non-soluble polyacrylate polymers, hydrophobically modified cross-linked polyacrylate polymers and copolymers containing at least one hydrophobic monomer, water dispersible associative and non-associative polyacrylate polymers and copolymers containing at least one acrylate monomer, and mixtures thereof. Examples of hydrophobically modified alkali soluble acrylic polymer emulsions are sold under the name ACUSOL® by Rohm and Haas. In additional suitable polymers, copolymers or derivatives thereof are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xantham and carrageen. Exemplary polymers are also selected from polyacrylates and water-soluble acrylate copolymers, methylcellulose, carboxymethylcellulose sodium, dextrin, ethylcellulose, hydroxyl-ethyl cellulose, hydroxypropyl methylcellulose, maltodextrin, polymethacrylates. Also suitable are polymers are selected from polyvinyl alcohols, polyvinyl alcohol copolymers, hydroxypropyl methyl cellulose (HPMC), xantham gum and starch. The polymer may have any weight average molecular weight from about 1000 to 1,000,000, or even from 10,000 to 300,000 or even from 15,000 to 200,000 or even from 20,000 to 150,000.

Also useful are polymer blend compositions, for example blends comprising a hydrolytically degradable and water-soluble polymer blend such as polylactide and polyvinyl alcohol, achieved by the mixing of polylactide and polyvinyl alcohol, typically comprising 1-35% by weight polylactide and approximately from 65% to 99% by weight polyvinyl alcohol, if the material is to be water-dispersible, or water-soluble.

Also suitable for use as rheology modifiers are inorganic thickeners, generally in the form of fine particulate additives including colloids and nanoparticulates. Examples of such inorganic thickeners include, but are not limited to materials such as natural clays, silicas, zeolites, finely divided metal oxides, finely divided inorganic minerals and nanoparticulate forms of such materials, and their mixtures. Also included are derivatized inorganic thickening agents, such as for example, fumed silica, silanized silica and hydrophobized silica, and the like. Examples of metal oxides include, but are not limited to, oxides of alkali metals, alkaline earth metals, transition metals of the Group IIA, IVB, VB, VIIB, VIII, IB, IIB, IIA and IVA periodic groups.

In suitable embodiments, the additional rheology modifier comprises 0.0001% by weight to about 15% by weight, or 0.001% by weight to about 10% by weight, or alternatively 0.01% by weight to about 5% by weight of the compositions of this disclosure.

### Alkalinity Source

The compositions of this disclosure may include an alkalinity source which is believed to increase the effectiveness of the surfactant and overall cleaning efficiency of the compositions. The alkalinity source may be a builder, a buffer and/or a pH adjusting agent which can also function as a water softener and/or a sequestering agent or chelating agent in the compositions of this disclosure. The builder, buffer and pH adjusting agents may be used alone, or in mixtures, or in combination with or in the form of their appropriate conjugate acids and/or conjugate bases, for adjusting and controlling the pH of the compositions of this disclosure.

A variety of builders or buffers can be used and they include, but are not limited to, phosphate-silicate compounds, zeolites, alkali metal, ammonium and substituted ammonium polyacetates, trialkali salts of nitrilotriacetic acid, carboxylates, polycarboxylates, carbonates, bicarbonates, polyphosphates, aminopolycarboxylates, polyhydroxysulfonates, and starch derivatives. Builders or buffers can also include polyacetates and polycarboxylates. The polyacetate and polycarboxylate compounds include, but are not limited to, sodium, potassium, lithium, ammonium, and substituted ammonium salts of ethylenediamine tetraacetic acid, ethylenediamine triacetic acid, ethylenediamine tetrapropionic acid, ethylenediamine-N,N′-disucinic acid (EDDS), diethylenetriamine pentaacetic acid, nitrilotriacetic acid, oxydisuccinic acid, iminodisuccinic acid (IDS), mellitic acid, polyaspartic acid, polyacrylic acid or polymethacrylic acid and copolymers, benzene polycarboxylic acids, gluconic acid, sulfamic acid, oxalic acid, phosphoric acid, phosphonic acid, organic phosphonic acids, acetic acid, and citric acid. These builders or buffers can also exist either partially or totally in the hydrogen ion form.

The builder agent can include sodium and/or potassium salts of EDTA and substituted ammonium salts. The substituted ammonium salts include, but are not limited to, ammonium salts of methylamine, dimethylamine, butylamine, butylenediamine, propylamine, triethylamine, trimethylamine, monoethanolamine, diethanolamine, triethanolamine, isopropanolamine, ethylenediamine tetraacetic acid and propanolamine.

Buffering and pH adjusting agents, when used, include, but are not limited to, organic acids, mineral acids, alkali metal and alkaline earth salts of silicate, metasilicate, polysilicate, borate, hydroxide, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and 2-amino-2methylpropanol. Suitable buffering agents for compositions of this disclosure are nitrogen-containing materials. Some examples are amino acids such as lysine or lower alcohol amines like monoalkanolamine, dialkanolamine and trialkanolamine. Examples of suitable alkanolamines include the mono-, di-, and tri-ethanolamines. Other suitable nitrogen-containing buffering agents are tri(hydroxymethyl)amino methane (TRIS), 2-amino-2-ethyl-1,3-propanediol, 2-amino-2-methyl-propanol, 2-amino-2-methyl-1,3-propanol, disodium glutamate, N-methyl diethanolarnide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine(bicine) and N-tris(hydroxymethyl)methyl glycine (tricine). Other suitable buffers include ammonium carbamate, citric acid, acetic acid. Mixtures of any of the above are also acceptable. Useful inorganic buffers/alkalinity sources include ammonia, the alkali metal carbonates and alkali metal phosphates, e.g., sodium carbonate, sodium polyphosphate. For additional buffers see WO 95/07971, which is incorporated herein by reference. Other suitable pH adjusting agents include sodium or potassium hydroxide.

Alkalinity sources such as ethylenediaminetetraacetic acid (“EDTA”) such as sold by the trade name VERSENE 100 may be used to aid in the removal of insoluble deposits of calcium and magnesium soaps and/or as a scouring agent. Moreover a number of salts of EDTA sometimes referred to as edetates are available such as calcium disodium, disodium edetates, tetrasodium, trisodium sodium ferric, dihydrogen ferrous and other disodium salts containing magnesium, cobalt manganese, copper, zinc, and nickel.

Preferred alkalinity sources useful in the sprayable cleaning compositions of this disclosure include, for example, ethylenediaminetetraacetic acid (EDTA), salts of ethylenediaminetetraacetic acid (EDTA), sodium metasilicate, monoethanloamine (MEA), trimethanolamine (TEA), and the like.

The alkalinity sources are used in amounts of about 1 weight percent to about 8 weight percent, preferably from about 2 weight percent to about 7 weight percent, and more preferably from about 5 weight percent to about 7 weight percent,

Alternatively, the alkalinity source, builder, buffer, or pH adjusting agent comprises at least about 0.001% and typically about 0.01% to 5% of the compositions of this disclosure. Also, alternatively, the builder, buffer or pH adjusting agent content is about 0.01% to 2%.

### Surfactant

Illustrative surfactants for use herein include the amine oxide surfactants and the alkyl amphocarboxylic acids. Suitable amine oxides include those compounds having the formula R³(OR⁴)ₓNO(R⁵)₂ wherein R³ is selected from an alkyl, hydroxyalkyl, acylamidopropyl and alkylphenyl group, or mixtures thereof, containing from 8 to 26 carbon atoms; R⁴ is an alkylene or hydroxyalkylene group containing from 2 to 3 carbon atoms, or mixtures thereof, x is from 0 to 5, alternatively from 0 to 3; and each R⁵ is an alkyl or hydroxyalkyl group containing from 1 to 3, or a polyethylene oxide group containing from 1 to 3 ethylene oxide groups. Suitable amine oxides are C10-C18 alkyl dimethylamine oxide, and C10-18 acylamido alkyl dimethylamine oxide. A suitable example of an alkyl amphodicarboxylic acid is Miranol™ C2M Conc. manufactured by Miranol, Inc., Dayton, N.J.

Preferred surfactants useful in the sprayable cleaning compositions of this disclosure include, for example, N-alkyl(C₁₂₋₁₆)dimethylamine oxides (cocamine oxide), sodium lauriminodipropionate, disodium lauroamphodiacetate, and the like.

The surfactants are used in amounts of about 0.3 weight percent to about 5 weight percent, preferably from about 0.5 weight percent to about 3 weight percent, and more preferably from about 1 weight percent to about 2 weight percent.

The cleaning compositions of this disclosure may contain one or more surfactants. The one or more other surfactants are selected from anionic, nonionic, cationic, amphoteric, ampholytic, and zwitterionic surfactants and mixtures thereof. A typical listing of anionic, nonionic, amphoteric, ampholytic, and zwitterionic classes, and species of these surfactants, is given in U.S. Pat. No. 3,929,678, which is hereby incorporated by reference. A list of suitable cationic surfactants is given in U.S. Pat. No. 4,259,217, which is hereby incorporated by reference. Amphoteric surfactants can be used in combination with one or more anionic and/or nonionic surfactants. Where present, ampholytic and zwitterionic surfactants are generally used in combination with one or more anionic and/or nonionic surfactants.

The cleaning compositions of this disclosure may contain an anionic surfactant. Essentially any anionic surfactants useful for detersive purposes can be comprised in the compositions of this disclosure. These can include salts (including, for example, sodium, potassium, ammonium, and substituted ammonium salts such as mono-, di- and tri-ethanolamine salts) of the anionic sulfate, sulfonate, carboxylate and sarcosinate surfactants. Anionic surfactants may comprise a sulfonate or a sulfate surfactant. Anionic surfactants may comprise an alkyl sulfate, a linear or branched alkyl benzene sulfonate, or an alkyldiphenyloxide disulfonate, as described herein. Preferred anionic surfactants, include but are not limited to, secondary alkane sulphonate sodium salt surfactants like HOSTAPUR® SAS 30, HOSTAPUR® SAS 60, both sold by Clariant Functional Chemicals and alkoxylate sulfate surfactant like TRITON™ W30, sold by The Dow Chemical Company.

Other anionic surfactants include the isethionates such as the acyl isethionates, N-acyl taurates, fatty acid amides of methyl tauride, alkyl succinates and sulfosuccinates, monoesters of sulfosuccinate (for instance, saturated and unsaturated C12-C18 monoesters), diesters of sulfosuccinate (for instance saturated and unsaturated C6-C14 diesters), N-acyl sarcosinates. Resin acids and hydrogenated resin acids are also suitable, such as rosin, hydrogenated rosin, and resin acids and hydrogenated resin acids present in or derived from tallow oil. Anionic sulfate surfactants suitable for use herein include the linear and branched primary and secondary alkyl sulfates, alkyl ethoxysulfates, fatty oleoyl glycerol sulfates, alkyl phenol ethylene oxide ether sulfates, the C5-C 17 acyl-N-(C1-C4 alkyl) and —N-(C1-C2hydroxyalkyl)glucamine sulfates, and sulfates of alkylpolysaccharides such as the sulfates of alkylpolyglucoside (the nonionic non-sulfated compounds being described herein). Alkyl sulfate surfactants may be selected from the linear and branched primary C10-C18 alkyl sulfates, the C11-C15 branched chain alkyl sulfates, or the C12-C14 linear chain alkyl sulfates.

Alkyl ethoxysulfate surfactants may be selected from the group consisting of the C10-C18 alkyl sulfates which have been ethoxylated with from 0.5 to 20 moles of ethylene oxide per molecule. The alkyl ethoxysulfate surfactant may be a C11-C18, or a C11-C15 alkyl sulfate which has been ethoxylated with from 0.5 to 7, or from 1 to 5, moles of ethylene oxide per molecule. One aspect of the disclosure employs mixtures of the alkyl sulfate and/or sulfonate and alkyl ethoxysulfate surfactants. Such mixtures have been disclosed in PCT Patent Application No. WO 93/18124, which is hereby incorporated by reference.

Anionic sulfonate surfactants suitable for use herein include the salts of C5-C20 linear alkylbenzene sulfonates, alkyl ester sulfonates, C6-C22 primary or secondary alkane sulfonates, C6-C24 olefin sulfonates, sulfonated polycarboxylic acids, alkyl glycerol sulfonates, fatty acyl glycerol sulfonates, fatty oleoyl glycerol sulfonates, and any mixtures thereof. Suitable anionic carboxylate surfactants include the alkyl ethoxy carboxylates, the alkyl polyethoxy polycarboxylate surfactants and the soaps (alkyl carboxyl), especially certain secondary soaps as described herein. Suitable alkyl ethoxy carboxylates include those with the formula RO(CH₂CH₂₀)ₓCH₂COO⁻M⁺ wherein R is a C6 to C18 alkyl group, x ranges from 0 to 10, and the ethoxylate distribution is such that, on a weight basis, the amount of material where x is 0 is less than 20% and M is a cation. Suitable alkyl polyethoxypolycarboxylate surfactants include those having the formula RO—(CHR¹—CHR²—O)—R³ wherein R is a C6 to C18 alkyl group, x is from 1 to 25, R¹ and R² are selected from the group consisting of hydrogen, methyl acid radical, succinic acid radical, hydroxysuccinic acid radical, and mixtures thereof, and R³ is selected from the group consisting of hydrogen, substituted or unsubstituted hydrocarbon having between 1 and 8 carbon atoms, and mixtures thereof.

Suitable soap surfactants include the secondary soap surfactants, which contain a carboxyl unit connected to a secondary carbon. Suitable secondary soap surfactants for use herein are water-soluble members selected from the group consisting of the water-soluble salts of 2-methyl-1-undecanoic acid, 2-ethyl-1-decanoic acid, 2-propyl-1-nonanoic acid, 2-butyl-1-octanoic acid and 2-pentyl-1-heptanoic acid. Certain soaps may also be included as suds suppressors.

Other suitable anionic surfactants are the alkali metal sarcosinates of formula R—CON(R¹)CH—)COOM, wherein R is a C5-C17 linear or branched alkyl or alkenyl group, R¹ is a C1-C4 alkyl group and M is an alkali metal ion. Examples are the myristyl and oleoyl methyl sarcosinates in the form of their sodium salts.

Essentially any alkoxylated nonionic surfactants are suitable herein, for instance, ethoxylated and propoxylated nonionic surfactants. Alkoxylated surfactants can be selected from the classes of the nonionic condensates of alkyl phenols, nonionic ethoxylated alcohols, nonionic ethoxylated/propoxylated fatty alcohols, nonionic ethoxylate/propoxylate condensates with propylene glycol, and the nonionic ethoxylate condensation products with propylene oxide/ethylene diamine adducts. Preferred nonionic surfactants, include but are not limited to, polyglycol ether nonionic surfactants, like TMN-6 TERGITOL® supplied by SIGMA-ALDRICH®, lauryl alcohol ethoxylated nonionic surfactants, like SURFONIC® L12 Series, supplied by Huntsman Performance Products, and ethoxylated linear primary alcohol nonionic surfactants, like SURFONIC® L Series, specifically SURFONIC® LSF 23-9, both supplied by Huntsman Performance Products.

The condensation products of aliphatic alcohols with from 1 to 25 moles of alkylene oxide, particularly ethylene oxide and/or propylene oxide, are suitable for use herein. The alkyl chain of the aliphatic alcohol can either be straight or branched, primary or secondary, and generally contains from 6 to 22 carbon atoms. Also suitable are the condensation products of alcohols having an alkyl group containing from 8 to 20 carbon atoms with from 2 to 10 moles of ethylene oxide per mole of alcohol.

Polyhydroxy fatty acid amides suitable for use herein are those having the structural formula R²CONR¹Z wherein: R¹ is H, C1-C4 hydrocarbyl, 2-hydroxyethyl, 2-hydroxypropyl, ethoxy, propoxy, or a mixture thereof, for instance, C1-C4 alkyl, or C1 or C2 alkyl; and R2 is a C5-C31 hydrocarbyl, for instance, straight-chain C5-C19 alkyl or alkenyl, or straight-chain C9-C17 alkyl or alkenyl, or straight-chain C11-C17 alkyl or alkenyl, or mixture thereof-, and Z is a polyhydroxyhydrocarbyl having a linear hydrocarbyl chain with at least 3 hydroxyls directly connected to the chain, or an alkoxylated derivative (for example, ethoxylated or propoxylated) thereof. Z may be derived from a reducing sugar in a reductive amination reaction, for example, Z is a glycidyl.

Suitable fatty acid amide surfactants include those having the formula: R¹CON(R²)₂ wherein R¹ is an alkyl group containing from 7 to 21, or from 9 to 17 carbon atoms and each R² is selected from the group consisting of hydrogen, C1-C4 alkyl, C1-C4 hydroxyalkyl, and —(C₂H₄O)ₓH, where x is in the range of from 1 to 3.

Suitable alkylpolysaccharides for use herein are disclosed in U.S. Pat. No. 4,565,647 having a hydrophobic group containing from 6 to 30 carbon atoms and a polysaccharide, e.g., a polyglycoside, hydrophilic group containing from 1.3 to 10 saccharide units. Alkylpolyglycosides may have the formula: R²O(Cₙ₁H₂ₙO)ₜ(glycosyl)ₓ wherein R² is selected from the group consisting of alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 8. The glycosyl may be derived from glucose.

Zwitterionic surfactants can also be incorporated into the compositions of this disclosure. These surfactants can be broadly described as derivatives of secondary and tertiary amines, derivatives of heterocyclic secondary and tertiary amines, or derivatives of quaternary ammonium, quaternary phosphonium or tertiary sulfonium compounds. Betaine and sultaine surfactants are exemplary zwitterionic surfactants for use herein.

Suitable betaines are those compounds having the formula R(R¹)₂N⁺R₂COO⁻ wherein R is a C6-C18 hydrocarbyl group, each R¹ is typically C1-C3 alkyl, and R² is a C1-C5 hydrocarbyl group. Suitable betaines are C12-18 dimethyl-ammonium hexanoate and the C10-18 acylamidopropane (or ethane) dimethyl (or diethyl) betaines. Complex betaine surfactants are also suitable for use herein.

Suitable cationic surfactants to be used herein include the quaternary ammonium surfactants. The quaternary ammonium surfactant may be a mono C6-C16, or a C6-C10 N-alkyl or alkenyl ammonium surfactant wherein the remaining N positions are substituted by methyl, hydroxyethyl or hydroxypropyl groups. Suitable are also the mono-alkoxylated and bis-alkoxylated amine surfactants.

Another suitable group of cationic surfactants, which can be used in the compositions of this disclosure, are cationic ester surfactants. The cationic ester surfactant is a compound having surfactant properties comprising at least one ester (i.e. —COO—) linkage and at least one cationically charged group. Suitable cationic ester surfactants, including choline ester surfactants, have for example been disclosed in U.S. Pat. Nos. 4,228,042, 4,239,660 and 4,260,529, which are all hereby incorporated by reference. The ester linkage and cationically charged group may be separated from each other in the surfactant molecule by a spacer group consisting of a chain comprising at least three atoms (i.e., of three atoms chain length), or from three to eight atoms, or from three to five atoms, or three atoms. The atoms forming the spacer group chain are selected from the group consisting, of carbon, nitrogen and oxygen atoms and any mixtures thereof, with the proviso that any nitrogen or oxygen atom in said chain connects only with carbon atoms in the chain. Thus spacer groups having, for example, —O—O—(i.e., peroxide), —N—N—, and —N—O— linkages are excluded, whilst spacer groups having, for example —CH₂—O—, CH₂— and —CH₂— NH—CH₂— linkages are included. The spacer group chain may comprise only carbon atoms, or the chain is a hydrocarbyl chain.

The compositions of this disclosure may comprise cationic mono-alkoxylated amine surfactants, for instance, of the general formula: R¹R²R³N⁺ApR⁴X⁻ wherein R¹ is an alkyl or alkenyl moiety containing from about 6 to about 18 carbon atoms, or from 6 to about 16 carbon atoms, or from about 6 to about 14 carbon atoms; R² and R³ are each independently alkyl groups containing from one to about three carbon atoms, for instance, methyl, for instance, both R² and R³ are methyl groups; R⁴ is selected from hydrogen, methyl and ethyl; X⁻ is an anion such as chloride, bromide, methylsulfate, sulfate, or the like, to provide electrical neutrality; A is a alkoxy group, especially a ethoxy, propoxy or butoxy group; and p is from 0 to about 30, or from 2 to about 15, or from 2 to about 8. The ApR⁴ group in the formula may have p=1 and is a hydroxyalkyl group, having no greater than 6 carbon atoms whereby the —OH group is separated from the quaternary ammonium nitrogen atom by no more than 3 carbon atoms. Suitable ApR⁴ groups are —CH₂CH₂-0H, —CH₂CH₂CH₂0H, —CH₂CH(CH₃)—OH and —CH(CH₃)CH₂—OH. Suitable R¹ groups are linear alkyl groups, for instance, linear R¹ groups having from 8 to 14 carbon atoms.

Suitable cationic mono-alkoxylated amine surfactants for use herein are of the formula R¹(CH₃)(CH₃)N⁺(CH₂CH₂O)₂₋₅HX⁻ wherein R¹ C10-C18 hydrocarbyl and mixtures thereof, especially C10-C14 alkyl, or C10 and C12 alkyl, and Xis any convenient anion to provide charge balance, for instance, chloride or bromide. As noted, compounds of the foregoing type include those wherein the ethoxy (CH₂CH₂O) units (EO) are replaced by butoxy, isopropoxy [CH(CH₃)CH₂O] and [CH₂CH(CH₃)O] units (i-Pr) or n-propoxy units (Pr), or mixtures of EO and/or Pr and/or i-Pr units.

The cationic bis-alkoxylated amine surfactant may have the general formula: R¹R²N⁺ApR³A′qR⁴X⁻ wherein R¹ is an alkyl or alkenyl moiety containing from about 8 to about 18 carbon atoms, or from 10 to about 16 carbon atoms, or from about 10 to about 14 carbon atoms; R² is an alkyl group containing from one to three carbon atoms, for instance, methyl; R³ and R⁴ can vary independently and are selected from hydrogen, methyl and ethyl, X⁻ is an anion such as chloride, bromide, methylsulfate, sulfate, or the like, sufficient to provide electrical neutrality. A and A′ can vary independently and are each selected from C1-C4 alkoxy, for instance, ethoxy, (i.e., —CH₂CH₂O—), propoxy, butoxy and mixtures thereof, p is from 1 to about 30, or from 1 to about 4 and q is from 1 to about 30, or from 1 to about 4, or both p and q are 1.

Suitable cationic bis-alkoxylated amine surfactants for use herein are of the formula R¹CH₃N⁺(CH₂CH₂OH)(CH₂CH₂OH)X⁻, wherein R¹ is C10-C18 hydrocarbyl and mixtures thereof, or C10, C12, C14 alkyl and mixtures thereof, X⁻ is any convenient anion to provide charge balance, for example, chloride. With reference to the general cationic bis-alkoxylated amine structure noted above, since in one example compound R¹ is derived from (coconut) C12-C14 alkyl fraction fatty acids, R² is methyl and ApR³ and A′qR⁴ are each monoethoxy.

Other cationic bis-alkoxylated amine surfactants useful herein include compounds of the formula: R¹R²N⁺—(CH₂CH₂O)ₚH—(CH₂CH₂O)_{q}H X⁻ wherein R¹ is C10-C18 hydrocarbyl, or C10-C14 alkyl, independently p is 1 to about 3 and q is 1 to about 3, R² is C1-C3 alkyl, for example, methyl, and X⁻ is an anion, for example, chloride or bromide. Other compounds of the foregoing type include those wherein the ethoxy (CH₂CH₂O) units (EO) are replaced by butoxy (Bu) isopropoxy [CH(CH₃)CH₂O] and [CH₂CH(CH₃)O] units (i-Pr) or n-propoxy units (Pr), or mixtures of EO and/or Pr and/or i-Pr units.

The compositions of this disclosure may include a fluorosurfactant selected from nonionic fluorosurfactants, cationic fluorosurfactants, and mixtures thereof which are soluble or dispersible in the aqueous compositions being taught herein, sometimes compositions which do not include further detersive surfactants, or further organic solvents, or both. Suitable nonionic fluorosurfactant compounds are found among the materials presently commercially marketed under the trade name Fluorad® (ex. 3M Corp.) Exemplary fluorosurfactants include those sold as Fluorad® FC-740, generally described to be fluorinated alkyl esters; Fluorad® FC-430, generally described to be fluorinated alkyl esters; Fluorad® FC-431, generally described to be fluorinated alkyl esters; and, Fluorad® FC-170-C, which is generally described as being fluorinated alkyl polyoxyethylene ethanols.

Suitable nonionic fluorosurfactant compounds include those which is believed to conform to the following formulation:

CₙF₂ₙ₊₁SO₂N(C₂H₅)(CH₂CH₂O)ₓCH₃

wherein: n has a value of from 1-12, or from 4-12, or 8; x has a value of from 4-18, or from 4-10, or 7; which is described to be a nonionic fluorinated alkyl alkoxylate and which is sold as Fluorad® FC-171 (ex. 3M Corp., formerly Minnesota Mining and Manufacturing Co.).

Additionally suitable nonionic fluorosurfactant compounds are also found among the materials marketed under the trade name ZONYL® (DuPont Performance Chemicals). These include, for example, ZONYL® FSO and ZONYL® FSN. These compounds have the following formula:

RfCH₂CH₂O(CH₂CH₂O)ₓH

where Rf is CF₃(CF₂CF₂)_{y}. For ZONYL® FSO, x is 0 to about 15 and y is 1 to about 7. For ZONYL® FSN, x is 0 to about 25 and y is 1 to about 9.

An example of a suitable cationic fluorosurfactant compound has the following structure: CₙF₂ₙ₊₁SO₂NHC₃H₆N⁺(CH₃)₃I⁻ where n is about.8. This cationic fluorosurfactant is available under the trade name Fluorad® FC-135 from 3M. Another example of a suitable cationic fluorosurfactant is CF₃—(CF₂)ₙ—(CH₂)ₘSCH₂CHOH—CH₂—N⁺RᵢR₂R₃Cl⁻ wherein: n is 5-9 and m is 2, and R₁, R₂ and R₃ are —CH₃. This cationic fluorosurfactant is available under the trade name ZONYL® FSD (available from DuPont, described as 2-hydroxy-3-((gamma-omega-perfluoro-C₆₋₂₀-alkyl)thio)-N,N,N-trimethyl-1-propyl ammonium chloride). Other cationic fluorosurfactants suitable for use in the present disclosure are also described in EP 866,115 to Leach and Niwata, which is hereby incorporated by reference.

The one or more other surfactants may be present in the compositions of the present disclosure at a level of from about 0.01% to 20%, or from about 0.1% to 10%, or from about 0.1% to 5% by weight.

### Solvent

In one embodiment of the disclosure, the cleaning composition does not contain any organic solvent. Instead of an organic solvent, the composition contains about 65% to about 95% water, or alternatively about 70% to 85% water, or alternatively about 75% to 85% water by weight of the composition. In one embodiment, the composition is essentially free of organic solvents because they contribute to a smeared or hazy appearance once the cleaning composition has dried on the surface. In this embodiment is it preferable to keep the cleaning composition free of organic solvents so that the composition forms a uniform, glossy and clear coating on the automotive surfaces.

In another embodiment of the disclosure the organic solvent comprises less than 1% of the composition, more preferably less than 0.5% of the composition and most preferably less than 0.01 percent of the composition. In a third embodiment of the disclosure, the cleaning composition comprises a small amount of solvent to assist in removing dirt, grease, and other unwanted impurities from the surface to be treated. The particular solvent employed in the compositions of this disclosure may be selected depending on the particular end use application, and particularly on the type of surface to be treated. In addition, the solvent may serve to help solubilize non-water soluble or poorly water soluble adjuvants, such as ultraviolet light (UV) absorbers, fragrances, perfumes and the like, for the purpose of preventing separation of these ingredients in the compositions of this disclosure. Suitable solvents include both hydrophilic and hydrophobic compounds, generally comprising solvents that are water soluble, water-miscible as well as water insoluble and water-immiscible compounds. Mixtures of any solvent may optionally be employed in the compositions of this disclosure.

Suitable organic solvents include, but are not limited to monohydric alcohols and polyhydric alcohols, such as for example C₁₋₆ alkanols and C₁₋₆ diols, alkylene glycols, such as for example C₁₋₁₀ alkyl ethers of alkylene glycols, glycol ethers, such as for example C₃₋₂₄ alkylene glycol ethers, polyalkylene glycols, short chain carboxylic acids, short chain esters, isoparaffinic hydrocarbons, mineral spirits, alkylaromatics, terpenes, terpene derivatives, terpenoids, terpenoid derivatives, formaldehyde, and pyrrolidones. Alkanols include, but are not limited to the monohydric alcohols including for example methanol, ethanol, n-propanol, isopropanol, butanol, pentanol, and hexanol, and isomers thereof. Diols include, but are not limited to, methylene, ethylene, propylene and butylene glycols. Alkylene glycol ethers include, but are not limited to, ethylene glycol monopropyl ether, ethylene glycol monobutyl ether, ethylene glycol monohexyl ether, diethylene glycol monopropyl ether, diethylene glycol monobutyl ether, diethylene glycol monohexyl ether, propylene glycol methyl ether, propylene glycol ethyl ether, propylene glycol n-propyl ether, propylene glycol monobutyl ether, propylene glycol t-butyl ether, di- or tri-polypropylene glycol methyl or ethyl or propyl or butyl ether, acetate and propionate esters of glycol ethers. Short chain carboxylic acids include, but are not limited to, acetic acid, glycolic acid, lactic acid and propionic acid. Short chain esters include, but are not limited to, glycol acetate, and cyclic or linear volatile methylsiloxanes. Water insoluble solvents such as isoparaffinic hydrocarbons, mineral spirits, alkylaromatics, terpenoids, terpenoid derivatives, terpenes, and terpenes derivatives can be mixed with a water soluble solvent when employed.

Examples of organic solvent having a vapor pressure less than 0.1 mm Hg (20° C.) include, but are not limited to, dipropylene glycol n-propyl ether, dipropylene glycol t-butyl ether, dipropylene glycol n-butyl ether, tripropylene glycol methyl ether, tripropylene glycol n-butyl ether, diethylene glycol propyl ether, diethylene glycol butyl ether, dipropylene glycol methyl ether acetate, diethylene glycol ethyl ether acetate, and diethylene glycol butyl ether acetate (all available from ARCO Chemical Company).

### Adjuncts

The compositions of this disclosure may contain additional optional adjuncts, such as one or more cleaning agents, cleaning aids, protective agents, chelators, builders, bases, cosolvents, cosurfactants, descalers, foam boosters, foam suppressants, surface modification agents, pH adjustors, pH buffers, wetting agents, stain and soil repellants, waxes, resins, polishes, abrasives, colloid stabilizers, waxes, lubricants, odor control agents, perfumes, fragrances and fragrance release agents, brighteners, fluorescent whitening agents, ultraviolet light (UV) absorbers, UV scatterers, excited state quenchers, anti-oxidants, oxygen quenchers, bleaching agents, electrolytes, dyes and/or colorants, phase stabilizers, emulsifiers, thickeners, defoamers, hydrotropes, cloud point modifiers, antimicrobial agents, preservatives, and mixtures thereof.

These optional one or more adjuncts may be employed in embodiments of the compositions of this disclosure to provide further cleaning benefits or functionality to the compositions.

When employed, these one or more optional adjuncts may individually comprise 0.0001% by weight to about 5% by weight, or 0.001% by weight to about 5% by weight, or alternatively 0.01% by weight to about 1% by weight of the compositions of this disclosure.

In particular, the bases (e.g., sodium hydroxide) are used in amounts of about 0.1 weight percent to about 2 weight percent preferably from about 0.1 weight percent to about 1.8 weight percent, and more preferably from about 0.2 weight percent to about 1.6 weight percent.

### Method of Use

The sprayable cleaning compositions disclosed herein are effective at cleaning tire and wheel surfaces. The wheel surfaces can be formed of painted steel, painted aluminum, chrome, stainless steel, clear coated aluminum, plastic, or the like. The cleaning formulations are effective at removing brake dust, road soils, and the partially oxidized organic layer which binds the soil to the wheel. The cleaning compositions are capable of cleaning the wheels without etching or pitting them.

The cleaning compositions of the present disclosure are also employed to clean the surfaces of vehicles, including for example, but not limited to automobiles, trucks, aeroplanes, motorcycles, boats, marine vehicles, trailers, recreational vehicles, jet skis, snowmobiles, bicycles, tractors and scooters. The compositions of the present disclosure are suitably used to treat and clean a variety of surface materials that is materials of construction, including but not limited to, rubber, elastomer, tires, wheels, wheel covers, tarpaulins, vehicular covers, and combinations thereof. Depending on application method, concentration and dwell time, the compositions of the present disclosure are suitably used to treat and clean a variety of other surface materials, including but not limited to, vinyl, leather, plastics, wood, and combinations thereof.

In one embodiment, compositions of the present disclosure may be applied directly onto a soiled or clean tire or wheel surface or automotive surface, preferably by a manual sprayer or an aerosol sprayer. Alternatively, in other embodiment, compositions of the present disclosure may be applied onto an applicator, including for example, but not limited to, a sponge, wipe, towel, towelette, squeegee, absorbent cloth, foam, shami, or similar carrier or tool employing a combination thereof. In both methods of use, the Vertical Cling time of the compositions of this disclosure is sufficient to substantially retain the applied compositions at the desired location. In embodiments in which the compositions of the present disclosure are first applied to an applicator and then applied to the soiled exterior surface or soiled material surface, the Vertical Cling time of the applied compositions of this disclosure is sufficient to substantially retain the applied compositions at the desired location.

### Application Means

Compositions of the present disclosure may be also be sprayed directly onto the target surface and therefore may be packaged in a spray dispenser. The spray dispenser can be any of the manually activated means for producing a spray of liquid droplets as is known in the art, e.g. trigger-type, pump-type, electrical spray, hydraulic nozzle, sonic nebulizer, high pressure fog nozzle, non-aerosol self-pressurized, and aerosol-type spray means. Automatic activated means can also be used herein. These types of automatic means are similar to manually activated means with the exception that the propellant is replaced by a compressor.

The spray dispenser can be an aerosol dispenser. The aerosol dispenser comprises a container which can be constructed of any of the conventional materials employed in fabricating aerosol containers. The dispenser must be capable of withstanding internal pressure in the range of from about 5 to about 120 p.s.i.g. or alternatively from about 10 to about 100 p.s.i.g. The one important requirement concerning the dispenser is that it be provided with a valve member which will permit the compositions of this disclosure contained in the dispenser to be dispensed in the form of a continuous stream or continuous spray of droplets. The aerosol dispenser utilizes a pressurized sealed container from which the compositions of this disclosure are dispensed through an actuator/valve assembly under pressure. The aerosol dispenser is pressurized by incorporating therein a gaseous component generally known as a propellant. A more complete description of commercially available aerosol-spray dispensers appears in U.S. Pat. Nos. 3,436,772 and 3,600,325, both of said references are incorporated herein by reference.

Alternatively in one embodiment, the spray dispenser can be a self-pressurized non-aerosol container having a convoluted liner and an elastomeric sleeve. Said self-pressurized dispenser comprises a liner/sleeve assembly containing a thin, flexible radially expandable convoluted plastic liner of from about 0.010 to about 0.020 inch thick, inside an essentially cylindrical elastomeric sleeve. The liner/sleeve is capable of holding a substantial quantity of odor-absorbing fluid product and of causing said product to be dispensed. A more complete description of self-pressurized spray dispensers can be found in U.S. Pat. Nos. 5,111,971 and 5,232,126, both of said references are herein incorporated by reference.

Another type of aerosol spray dispenser is one wherein a barrier separates the disclosure composition from the propellant (usually compressed air or nitrogen), as is disclosed in U.S. Pat. No. 4,260,110, incorporated herein by reference. Such a dispenser is available from EP Spray Systems, East Hanover, N.J.

In another embodiment of the present disclosure, the spray dispenser is a non-aerosol, manually activated, pump-spray dispenser. Said pump-spray dispenser comprises a container and a pump mechanism which securely screws or snaps onto the container. The container comprises a vessel for containing the composition of this disclosure to be dispensed. The pump mechanism comprises a pump chamber of substantially fixed volume, having an opening at the inner end thereof. Within the pump chamber is located a pump stem having a piston on the end thereof disposed for reciprocal motion in the pump chamber. The pump stem has a passageway there through with a dispensing outlet at the outer end of the passageway and an axial inlet port located inwardly thereof.

The container and the pump mechanism can be constructed of any conventional material employed in fabricating pump-spray dispensers, including, but not limited to: polyethylene; polypropylene; polyethyleneterephthalate; blends of polyethylene, vinyl acetate, and rubber elastomer. Other materials can include stainless steel. A more complete disclosure of commercially available dispensing devices appears in: U.S. Pat. Nos. 4,895,279, 4,735,347, and 4,274, 560, all of said references are herein incorporated by reference.

In yet another embodiment, the spray dispenser is a manually activated trigger-spray dispenser. Said trigger-spray dispenser comprises a container and a trigger both of which can be constructed of any of the conventional material employed in fabricating trigger-spray dispensers, including, but not limited to: polyethylene; polypropylene; polyacetal; polycarbonate; polyethylenetere-phthalate; polyvinyl chloride; polystyrene; blends of polyethylene, vinyl acetate, and rubber elastomer. Other materials can include stainless steel and glass. The trigger-spray dispenser does not incorporate a propellant gas. The trigger-spray dispenser herein is typically one which acts upon a discrete amount of the composition of this disclosure itself, typically by means of a piston or a collapsing bellows that displaces the composition through a nozzle to create a stream or spray of liquid. Said trigger-spray dispenser typically comprises a pump chamber having either a piston or bellows which is movable through a limited stroke response to the trigger for varying the volume of said pump chamber. This pump chamber or bellows chamber collects and holds the product for dispensing.

The trigger spray dispenser typically has an outlet check valve for blocking communication and flow of fluid through the nozzle and is responsive to the pressure inside the chamber. For the piston type trigger sprayers, as the trigger is compressed, it acts on the fluid in the chamber and the spring, increasing the pressure on the fluid. For the bellows spray dispenser, as the bellows is compressed, the pressure increases on the fluid. The increase in fluid pressure in either trigger spray dispenser acts to open the top outlet check valve. The top valve allows the product to be forced through the swirl chamber and out the nozzle to form a discharge stream or pattern. An adjustable nozzle cap can be used to vary the pattern of the fluid dispensed. For the piston spray dispenser, as the trigger is released, the spring acts on the piston to return it to its original position. For the bellows spray dispenser, the bellows acts as the spring to return to its original position. This action causes a vacuum in the chamber. The responding fluid acts to close the outlet valve while opening the inlet valve drawing product up to the chamber from the reservoir.

A more complete disclosure of commercially available dispensing devices appears in U.S. Pat. Nos. 4,082,223, 4,161,288, 4,434,917, 4,819,835, and 5,303,867, all of said references are incorporated herein by reference. Broad arrays of trigger sprayers or finger pump sprayers are suitable for use with the compositions of this disclosure. These are readily available from suppliers such as Calmar, Inc., City of Industry, Calif.; CSI (Continental Sprayers, Inc.), St. Peters, Mo.; Berry Plastics Corp., Evansville, Ind.; or Seaquest Dispensing, Cary, Ill.

In general, the spray dispensers are most suitably employed with compositions of this disclosure that also display some degree of shear thinning character in addition to the Vertical Cling rheological characteristics of the present disclosure. Alternatively, the orifice size of the spray dispenser passageways, chambers, inlet and outlet orifices can be sized appropriately, which is to say generally enlarged in internal diameter with respect to sizes appropriate for thin liquids like water, to an extent governed by the viscosity of the compositions of this disclosure to provide suitable dispensing characteristics.

Various modifications and variations of this disclosure will be obvious to a worker skilled in the art and it is to be understood that such modifications and variations are to be included within the purview of this application and the spirit and scope of the claims.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

The present disclosure has been described above with reference to numerous embodiments and specific examples. Many variations will suggest themselves to those skilled in this art in light of the above detailed description. All such obvious variations are within the full intended scope of the appended claims.

### EXAMPLES

Cleaning compositions were prepared by adding deionized water to a glass, plastic or metal container and mixing with an impeller mixer. With the mixer mixing, a polysaccharide was added slowly into the mixture. A surfactant and alkalinity source were added separately and allowed to completely disperse. The final mixture was allowed to stir for about 15 minutes.

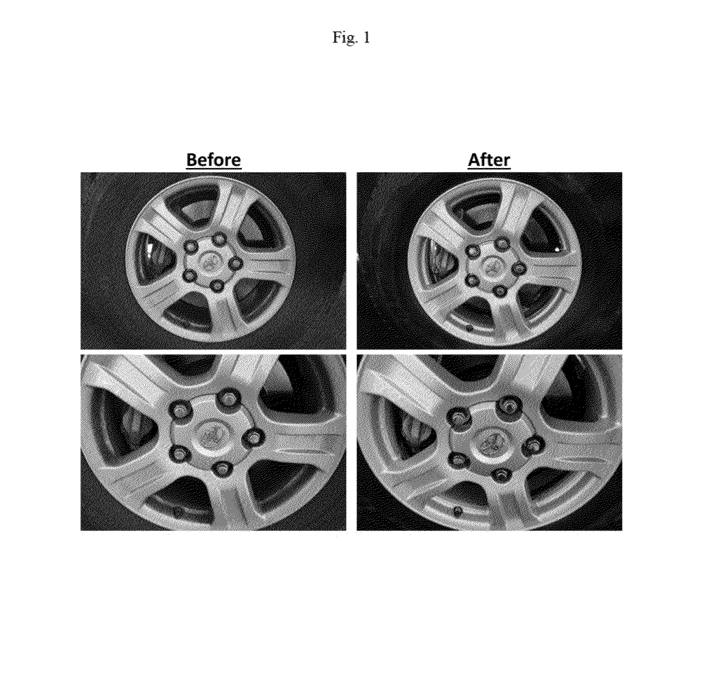

Cleaning performance was determined on a Toyota Tundra wheel and tire. The cleaning testing was conducted as follows: cleaning composition was sprayed uniformly over the entire wheel and tire; cleaning composition was allowed to soak for 5 minutes; cleaning composition was hosed off thoroughly; and the tire and wheel surface was dried with a clean, soft towel to prevent water spots. FIG. 1 show images of the tire and wheel taken before and after cleaning The cleaning composition was sprayed onto the entire wheel and allowed to saturate the surface for 5 minutes. FIG. 1 shows the Toyota Tundra wheel before (Left) and after (Right) cleaning with a wheel cleaning composition containing at least one polysaccharide.

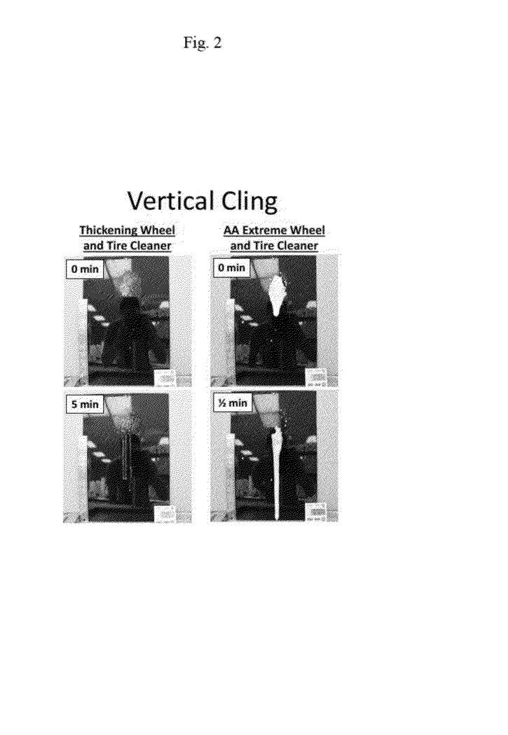

The Vertical Cling time of a liquid material was determined using a test panel made of a representative material selected for convenience of testing under controlled conditions. The representative material was a clear coated black painted metal panel (18 inches×12 inches) obtained from ACT Laboratories Co., Hillsdale, Mich., designated for Ford F-Series APR437222. During testing, the test panel was placed vertically (upright) so that the shortest dimension was parallel to the support surface. The test panel was locked into an upright position by resting against a vertical wall and using adhesive tape, which holds the panel at an angle of approximately 90° with respect to the support surface. This angle mimics the vertical surface of a wheel and tire and allows the applied liquid material to flow downwards along the surface of the test panel as it would on a wheel and tire. The vertical cling performance of one wheel cleaning composition, containing 0.34% polysaccharides (Left, Thickening Wheel and Tire Cleaner), compared to a composition containing 0% polysaccaharides (Right, AA Extreme Wheel and Tire Cleaner) is shown below in FIG. 2. The Thickening Wheel and Tire Cleaner takes longer to travel down the panel, indicating higher cling.

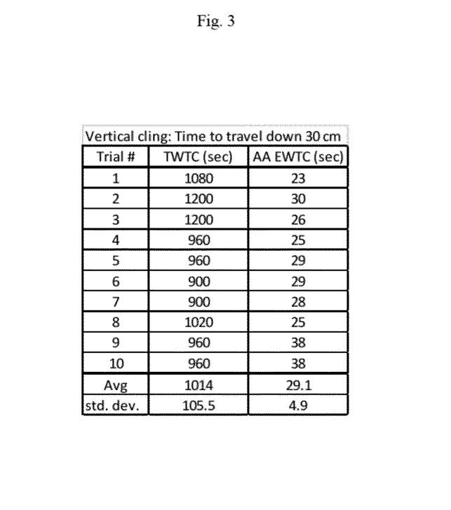

For the Vertical Cling test, formulas were sprayed through a 9.5 cm×9 cm acrylic panel, placed directly on the panel surface, to ensure uniform spray patterns. The product was sprayed 6 inches away from the panel. The solutions were then timed to travel 30 cm down the panel. The results are summarized in FIG. 3. As shown in FIG. 3, the wheel cleaning composition containing 0.34% polysaccharides took an average (n=10) of 1014 seconds, while the composition containing 0% polysaccharides took an average (n=10) of 29.1 seconds. Vertical cling test of two wheel cleaning composition, one containing 0.34% polysaccharide (Thickening Wheel and Tire Cleaner, TWTC), and with 0% polysaccharide (AA Extreme Wheel and Tire Cleaner, AA EWTC). The data indicates the time it took for the solution to travel 30 cm down the test panel; TWTC averaged at 1014 seconds, while AA EWTC averaged at 29.1 seconds.

For purposes of this disclosure, the Vertical Cling test used herein is referred to as Vertical Cling Test VCT1.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

The present disclosure has been described above with reference to numerous embodiments and specific examples. Many variations will suggest themselves to those skilled in this art in light of the above detailed description. All such obvious variations are within the full intended scope of the appended claims.

What is claimed is:

1. A sprayable cleaning composition comprising:
a rheology modifier in an amount of about 0.1 weight percent to about weight percent, wherein the rheology modifier comprises a polysaccharide,
an alkalinity source in an amount of about 1 weight percent to about weight percent,
a surfactant in an amount of about 0.3 weight percent to about 5 weight percent, wherein the surfactant comprises a nonionic, anionic, cationic, and/or amphoteric surfactant, and
water in an amount of about 80 weight percent to about 98 weight percent;
wherein the cleaning composition has a viscosity from about 200 cps to about 1000 cps and exhibits a Vertical Cling time of greater than about 5 minutes as measured by Vertical Cling Test VCT1.

2. The sprayable cleaning composition of claim 1 wherein said polysaccharide is selected from the group consisting of cellulose, chitin, dextran, and xanthan gum.

3. The sprayable cleaning composition of claim 1 wherein said alkalinity source is a chelating agent selected from the group consisting of ethylenediaminetetraacetic acid (EDTA), and salts of ethylenediaminetetraacetic acid (EDTA).

4. The sprayable cleaning composition of claim 1 wherein said surfactant is selected from the group consisting of N-a1kyl(C₁₂₋₁₆)dimethylamine oxides (cocamine oxide), alcohol (C₉-C₁₁) ethoxylates, sodium lauriminodipropionate, disodium lauroamphodiacetate dicocoalkyldimethylammonium chloride, and cocoamidopropyl betaine.

5. The sprayable cleaning composition of claim 1 further comprising:
a base in an amount of about 0.1 weight percent to about 2 weight percent.

6. The sprayable cleaning composition of claim 1 which exhibits a Vertical Cling time of greater than about 10 minutes as measured by Vertical Cling Test VCT1.

7. The sprayable cleaning composition of claim 1 which exhibits a Vertical Cling time of greater than about 15 minutes as measured by Vertical Cling Test VCT1.

8. The sprayable cleaning composition of claim 1 wherein said theology modifier is present in an amount of about 0.1 weight percent to about 0.6 weight percent, said alkalinity source is present in an amount of about 5 weight percent to about 7 weight percent, said surfactant is present in an amount of about 0.5 weight percent to about 3 weight percent, said base is present in an amount of about 0.5 weight percent to about 1.5 weight percent, and said water is present in an amount of about 85 weight percent to about 93 weight percent.

9. The sprayable cleaning composition of claim 1 wherein said polysacchaiide is xanthan gum, said alkalinity source is ethylenediaminetetraacetic acid (EDTA) or salts of ethylenediaminetetraacetic acid (EDTA), said surfactant is N-alkyl(C₁₂₋₁₆)dimethylamine oxides (cocamine oxide), and said water is deionized water.

10. The sprayable cleaning composition of claim 1 further comprising one or more adjuncts selected from the group consisting of rheology modifiers, builders, alkalizing agents, descalers, foam boosters, foam suppressants, surface modification agents, pH adjustors, pH buffers, wetting agents, stain and soil repellants, waxes, resins, polishes, colloid stabilizers, waxes, lubricants, odor control agents, perfumes, fragrances and fragrance release agents brighteners ultraviolet light (UV) absorbers, UV scatterers, dyes and/or colorants, phase stabilizers, emulsifiers, thickeners, defoamers, hydrotropes, cloud point modifiers, antimicrobial agents, and preservatives.

11. The sprayable cleaning composition of claim 1 which is a wheel and tire cleaning composition.

12. The sprayable cleaning composition of claim 1 which is an automotive cleaning composition.

13. The sprayable cleaning composition of claim 1 which is a sprayable cleaning composition.

14. A method for cleaning a surface, said method comprising:
spraying a cleaning composition to the surface to be cleaned;
allowing the cleaning composition to be contacted with the surface for a period of time sufficient to dissolve and/or emulsify organic soils; and
rinsing the cleaning composition and dissolved and/or emulsified organic soils from the surface with water;
wherein the cleaning composition comprises:
a rheology modifier in an amount of about 0.1 weight percent to about 1 weight percent, wherein the rheology modifier comprises a polysaccharide,
an alkalinity source in an amount of about 1 weight percent to about 8 weight percent,
a surfactant in an amount of about 0.3 weight percent to about 5 weight percent, wherein the surfactant comprises a nonionic, anionic, cationic, or amphoteric surfactant, or mixtures thereof, and
water in an amount of about 80 weight percent to about 98 weight percent;
wherein the cleaning composition has a viscosity from about 200 cps to about 1000 cps and exhibits a Vertical Cling time of greater than about 5 minutes as measured by Vertical Cling Test VC1.

15. The method of claim 14 wherein the surface is an inclined or vertical surface.

16. The method of claim 14 comprising allowing the cleaning composition to be contacted with the surface for a period of at least 5 minutes to dissolve and/or emulsify organic soils.

17. The method of claim 14 wherein the surface comprises aluminum, chrome. stainless steel, painted steel, painted aluminum, clear coated aluminum, plastic, fiberglass, or rubber.

18. The method of claim 14, wherein in the cleaning composition, said polysaccharide is selected from the group consisting of cellulose, chitin, dextran, and xanthan gum.

19. The method of claim 14, wherein the cleaning composition further comprises:
a base in an amount of about 0.1 weight percent to about 2 weight percent.

20. The method of claim 14, wherein in the cleaning composition, said alkalinity source is a chelating agent selected from the group consisting of ethylenediaminetetraacetic acid (EDTA), and salts of ethylenediaminetetraacetic acid (EDTA).

21. The method of claim 14, wherein in the cleaning composition, said surfactant is selected from the group consisting of N-alkyl(C₁₂₋₁₆)dimethylamine oxides (cocamine oxide), sodium lauriminodipropionate, and disodium lauroamphodiacetate.

22. The method of claim 14, wherein the cleaning composition exhibits a Vertical Cling time of greater than about 10 minutes as measured by Vertical Cling Test VCT1.

23. The method of claim 14, wherein in the cleaning composition exhibits a Vertical Cling time of greater than about 15 minutes as measured by Vertical Cling Test VCT1.

24. The method of claim 14, wherein in the cleaning composition, said rheology modifier is present in an amount of about 0.1 weight percent to about 0.6 weight percent, said alkalinity source is present in an amount of about 5 weight percent to about 7 weight percent, said surfactant is present in an amount of about 0.5 weight percent to about 3 weight percent, said base is present in an amount of about 0.5 weight percent to about 1.5 weight percent, and said water is present in an amount of about 85 weight percent to about 93 weight percent.

25. The method of claim 14, wherein in the cleaning composition, said polysaccharide is xanthan gum said alkalinity source is ethylenediaminetetraacetic acid (EDTA) or salts of etylenediaminetetraacetic acid (EDTA), said surfactant is N-alkyl(C₁₂₋₁₆)dimethylamine oxides (cocamine oxide), and said water is deionized water.

26. The method of claim 14, wherein the cleaning composition further comprises one or more adjuncts selected from the group consisting of rheology modifiers, builders, alkalizing agents, descalers, foam boosters, foam suppressants, surface modification agents, pH adjustors, pH buffers, wetting agents, stain and soil repellants, waxes, resins, polishes, colloid stabilizers, waxes, lubricants, odor control agents, perfumes, fragrances and fragrance release agents brighteners ultraviolet light (UV) absorbers, UV scatterers, dyes and/or colorants, phase stabilizers, emulsifiers, thickeners, defoamers, hydrotropes, cloud point modifiers, antimicrobial agents, and preservatives.

27. The method of claim 14, wherein the cleaning composition is a wheel and tire cleaning composition.

28. The method of claim 14, wherein the cleaning composition is an automotive cleaning composition.

29. The method of claim 14 in which the cleaning composition is a sprayable cleaning composition.
